(19) United States
(12) Patent Application Publication
(10) Pub. No.: US 2025/0286799 A1
(43) Pub. Date: Sep. 11, 2025

(54) METHOD FOR ESTIMATING LATENCY IN A NETWORK DISTRIBUTED SYSTEM

(71) Applicant: Robert Bosch GmbH, Stuttgart (DE)

(72) Inventors: Behnaz Pourmohseni, Muenchen (DE); Fedor Smirnov, Erlangen (DE); Kevin Schmidt, Herrenberg (DE); Laura Beermann, Waldbronn (DE); Paolo Pazzaglia, Tuebingen (DE)

(21) Appl. No.: 19/067,878

(22) Filed: Mar. 1, 2025

(30) Foreign Application Priority Data
Mar. 11, 2024 (DE) 10 2024 202 254.3

(51) Int. Cl. H04L 43/0852

(52) U.S. Cl. CPC H04L 43/0852

(57) ABSTRACT

A method for estimating latency in a network distributed system with at least one sensor, a control unit, and an actuator for actuating on a technical system includes (i) determining a sensor latency between the sensor and the control unit based on sensor time information, (ii) estimating an actuator latency between the control unit and the actuator, (iii) providing multiple control functions each concerning a different estimated total latency, wherein the estimated total latency includes the sensor latency, the actuator latency and a control latency, (iv) providing a latency correction term based on a comparison between the estimated total latency and a measured total latency, (v) calculating a corrected total latency by using (adding) the latency correction term, available at the time of the estimation, to the total latency, (vi) selecting and executing a control function from the multiple control functions for which the corrected total latency lies within a latency range of this control function and calculating a control input from the selected control function, (vii) transmitting the control input to the actuator via the network, and (viii) applying, by the actuator, the control input to the technical system.

This application claims priority under 35 U.S.C. § 119 to application no. DE 10 2024 202 254.3, filed on Mar. 11, 2024 in Germany, the disclosure of which is incorporated herein by reference in its entirety.

### BACKGROUND

Optimal control design is often hindered by the presence of unpredictable timing effects in the control chain. The effects of uncertain delays are particularly critical in distributed control systems, where the control algorithm and the system to be controlled (i.e., a physical plant or process) are separated, thus requiring a network to communicate, and where the computing platform resources may be shared with other concurrent applications.

Usually, no knowledge of the latency that will be experienced by the data flow through the control chain is available before actually starting the execution of the controller. Models available in the literature for computational and communication delays in distributed real-time systems mostly rely on pre-existent knowledge of probabilistic distributions of timing effects, to produce an upper- and lower-bound of the possible latencies. Such estimations are normally provided offline to check, e.g., worst-case schedulability, while online estimations are usually performed for adapting to variable workloads at runtime e.g., acceptance testing.

Additionally, the interval between the estimated best-case and worst-case latencies is usually large, and the actual latency value may change quickly across different iterations, depending on the operating conditions. Current approaches of delay-aware control design use either models to design offline robust control or are limited in being only reactive to delay changes. Another notable example in literature is feedback-scheduling, which uses feedback information from monitoring deadline misses and utilization changes to adapt the task schedule, but usually does not target distributed settings with communication delays.

There is no defined and fail-safe knowledge or prediction of the latencies within a distributed control loop, that is available at the time when the control input is calculated in the control function. The resulting latency from the sensor to the actuator can only be determined with certainty after the actuator has received the data, i.e., this knowledge is only available after the control input has been calculated.

### SUMMARY

A first aspect of the present disclosure relates to a method for estimating latency in a network distributed system with at least one sensor, a control unit and an actuator for actuating on a technical system.

The method of the present disclosure includes
Determine a sensor latency between the sensor and the control unit based on sensor time information,
Estimate an actuator latency between the control unit and the actuator,
Provide multiple control functions each concerning a different estimated total latency, wherein the estimated total latency includes the sensor latency, the actuator latency and a control latency,
Provide a latency correction term based on a comparison between the estimated total latency and a measured total latency, sensor time information and total latency, at actuator,
Calculate a corrected total latency by using the latency correction term, available at the time of the estimation, to the total latency,
Select and execute a control function from the multiple control functions for which the corrected total latency lies within a latency range of this control function and calculate a control input from the selected control function,
Transmit the control input to the actuator via the network,
Apply, by the actuator, the control input to the technical system.

A second aspect of the present disclosure relates to a control system comprising at least one sensor, a control unit and an actuator and being adapted to perform the method according to the first aspect (or an embodiment thereof).

A third aspect of the present disclosure relates to a computer system adapted to perform the method according to the first aspect (or an embodiment thereof).

A fourth aspect of the present disclosure relates to a computer program adapted to perform the method according to the first aspect (or an embodiment thereof).

A fifth aspect of the present disclosure relates to a computer readable medium or signal storing and/or containing the computer program according to the third aspect (or an embodiment thereof).

The technique of the first to fifth aspects can have advantageous technical effects.

The techniques of the present disclosure may provide an optimized decision process by providing the knowledge of the latency that will be experienced by the data flow through the control chain before actually starting the execution of the controller. For example, depending on the estimated latency, an appropriate control mode optimized for that delay could be chosen. This decision process can be repeated at every iteration of the control loop to adapt for changing operating conditions. Anyway, such latency knowledge will realistically be based on estimates that intrinsically bear some degree of inaccuracy, which can be balanced with a measurement-based compensation.

The techniques of the present disclosure may implement a low-complexity method to estimate the control chain latency at each k-th iteration, paired with a feedback mechanism that uses the knowledge of the real latency measured by the actuator in the previous iterations to correct the estimation. Thereby, sufficiently accurate information about the latency can be made available.

The techniques of the present disclosure disclosure may be used during the control design of various distributed systems that comprise powerful computational resources and where uncertain timing effects play a major role in the chain sensor-control-actuator.

The techniques of the present disclosure disclosure may be used to enhance the design of already existing control functions, when they are required to be deployed to a different distributed system, where they would experience different latencies. The original control design may be maintained if the delay experienced in some cases resembles the original design, while additional operating modes may be added to cover additional operating modes.

The techniques of the present disclosure may be used for V2V-communication e.g. for cooperative driving functions as connected adaptive cruise control, group start, cooperative lane merging, management of an intersection. An example may be a connected driving function for the longitudinal motion control. Further examples are the control/coordination of guided automated vehicles by a local network (local edge, 5G network, . . . ) in a restricted area, e.g. in logistic centers or production systems; the (partial) offboarding of the control algorithms of robotic arms to local networks, e.g. for manufacturing systems; and the lateral and/or longitudinal motion control of vehicles at traffic hubs or other control zones which is offboarded to a local edge or cloud system (e.g., a roadside unit).

Further, the techniques of the present disclosure may be used for robotics as e.g. swarm applications or floor conveyors. The techniques of the present disclosure may also be used for variable production lines with remote control over a network e.g. a centralized wireless control. The latencies in communication can thus be compensated for at the actuator thereby enabling precise time-critical production.

### BRIEF DESCRIPTION OF THE DRAWINGS

FIG. 1 is a flow diagram illustrating a method for controlling a distributed system according to the first aspect.

FIG. 2 shows schematically a distributed system of the present techniques.

FIG. 3 shows schematically a possible topology of the present techniques.

FIG. 4 shows schematically a possible topology of the present techniques.

### DETAILED DESCRIPTION

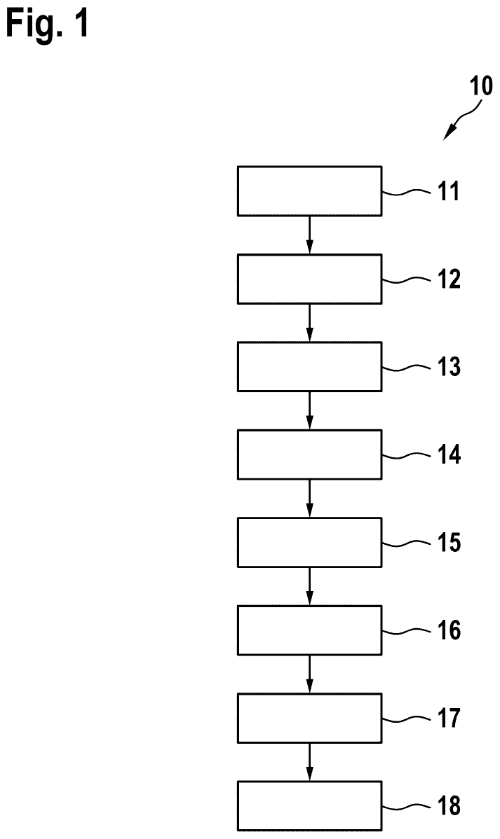

FIG. 1 discloses a method for estimating latency in a network distributed system with at least one sensor, a control unit and an actuator for actuating on a technical system. The distributed system may include a physical plant/process to be controlled, a sensor, a digital controller and an actuator in the following. The controller may execute on a cloud or edge device, or on a dedicated processor with significatively larger computational power than a classic embedded device. Sensor, controller and actuator are connected via a networked communication infrastructure. The physical/technical plant/process to be controlled may be included in or excluded from the distributed system. The sensor may measure at least one property of a technical system and the actuator may actuate at least one property of the technical system.

In a first step 11, determine a sensor latency between the sensor and the control unit based on sensor time information. The sensor time information may be created at the time of generation of the data or at the time of sending the data from the sensor. The time information may include an absolute time information such as a time stamp or a relative indication of time.

The term sensor latency (or delay) defines the timespan a signal needs to travel in the network from the sensor to the control unit.

In a further step 12, estimate (calculate or obtain) an actuator latency between the control unit and the actuator. To estimate the actuator latency may include to calculate the actuator latency or to obtain a pre-calculated actuator latency. The estimated actuator latency may be derived from at least one of historical data, network observation, run-time estimations, calculation delays, and sensor latency.

The term actuator latency (or delay) defines the timespan a signal needs to travel in the network from the control unit to the actuator.

In a further step 13, provide multiple control functions each concerning a different estimated total latency, wherein the estimated total latency includes or consists of the sensor latency, the actuator latency and a control latency. The control latency includes the timespan needed by the control unit to compute the control routines and compute the estimated total latency. The estimated total latency may consist of the sensor latency and the actuator latency when the sensor latency and the actuator latency are large compared to the control latency.

The number of control functions may be defined by a range of latencies to be covered. A control function or a mode is calculated for a certain latency range or band. This number of control functions may be limited to be smaller than ten. Depending on resource awareness and delay change this number may be higher.

In a further step 14, provide a latency correction term based on a comparison between the estimated total latency and a measured total latency. The measured total latency may be measured at the actuator using the sensor time information and and information of the arrival time of the signal to the actuator.

In a further step 15, calculate a corrected total latency by using e.g. including or adding the latency correction term available to the control unit to the estimated total latency.

In a further step 16, select and execute a control function from the multiple control functions for which the corrected total latency lies within a latency range of this control function and calculate a control input from the selected control function. In other words, the selected control function concerns the corrected total latency or was designed for it.

In a further step 17, transmit the control input to the actuator via the network. The respective estimated total latency of the transmitted control input may be integral to the control input and may be detectable by the actuator. Also, the respective estimated total latency may be provided additionally with their respective control inputs e.g. as a stamp.

In a further step 18, apply, by the actuator, the control input to the technical system.

The method may be run in a loop. The actuator provides a new latency correction term to the control unit which uses the new latency correction term to update the latency estimation and to iterate the selection of a control function.

The method 10 may further include the following initial method steps to be carried out before the first method step 11.
Receive, at the control unit, sensing data and time information from the sensor.
   Calculate, at the actuator, the latency correction term and transmit the latency correction term to the control unit.

Then, the method steps as described above are carried out. In detail, execute, at the control unit, the steps of Estimate an actuator latency, Calculate a corrected total latency, Select a control function and Transmit the control input.

The control functions may be ranked by best performance or resource need and selecting a control function from the multiple control functions may start with the highest ranked control function and continues to lower ranked control functions until a control function is identified for which the corrected total latency lies within the latency range of this control function. Such use of ranking may decrease the control delay and this increases robustness and reliability of the distributed system.

The control unit, the sensor and the actuator may be time synchronized so that a latency between the sensor and the control unit may be dynamically compensated. If the controller is synchronized with the actuator/sensor device(s), a dynamic compensation of the possibly variable delay between sensor and controller is possible. In addition, estimation schemes for the computational delay may be incorporated. In this case, the control unit may label the sent input values at generation of a control input with its own time information like a timestamp. This may decrease the amount of overall delay to be dealt with the control designs significantly. Further, the performance of the closed-loop system may be increased.

The sensor may measure at least one property of the technical system and outputs sensing data to the control unit and the actuator may receive a control input from the control unit and actuates at least one property of the technical system according to the control input

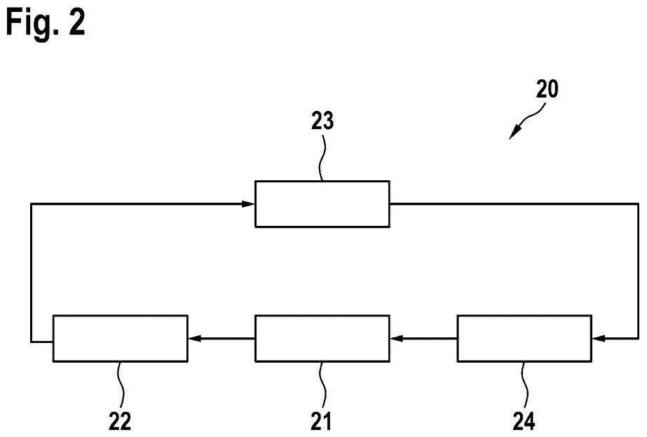

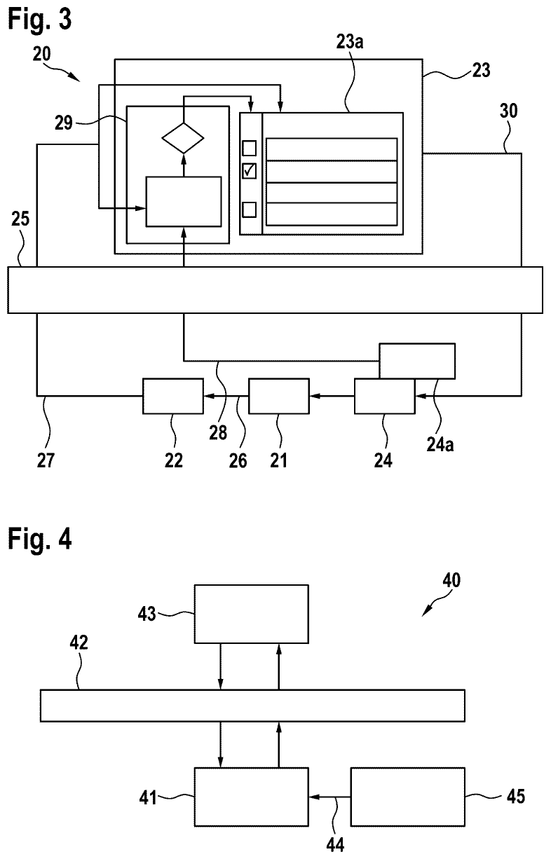

Features of the present disclosure described below in conjunction with FIG. 2 or 3 showing a control or computing system apply also to the method as described above.

FIG. 2 schematically shows a control or computing system 20 in which the techniques of the present disclosure can be used for controlling a distributed system. The computing system 20 may be implemented in hardware and/or software. Based on FIG. 2 the total latency is explained.

A distributed system including edge/cloud computational resources has many advantages, e.g. cheaper computational resources, more information of multiple input sources, centralized maintenance and more flexibility in resource allocation. This design is particularly suitable for implementing modern control systems, whose increasing complexity requires moving away from classic embedded solutions. Nevertheless, a higher uncertainty in latency during data transmission is one of the side effects of such a system.

From the perspective of the controlled system, the overall latency experienced by the data in the control chain (due to computation and communication) is the main driver of its stability and performance properties at runtime, especially when this latency is variable and uncertain.

The control chain in a networked/distributed setting consists of the following steps:
1. The plant or technical system 21 is sampled by the sensor 22 and its output is sent to the control unit 23. The control unit 23 executes on a node (cloud/edge/zone/embedded) possibly different than the one(s) where the sensor 22 and the actuator 24 are located.
2. The sensed data is used as input of the controller equations to update its internal states (if any) and obtain the corresponding control command, that is sent to the actuator 24.
3. The actuator 24 receives the control command and applies the corresponding action to the technical system 21.

In such a distributed control system, the latency of the control chain could be compensated for by a proper design of the controller. Since the delays are generally dynamically varying, multiple control modes can be provided, each optimized for certain latency conditions. However, their direct applicability is complex due to the intrinsic uncertainty of the timing effects at each of the three steps above, generated from both computational delays and latencies introduced by the communication network.

The latency of the entire chain can be confirmed only when the actuator receives the data (step 3 above), which naturally occurs after the control value has been calculated (step 2 above). Nonetheless, unlocking this knowledge before starting executing the control function (i.e., at the beginning of step 2 above) may open the door to an optimized control design. In particular, it would be possible to choose in advance the most suitable control mode to operate with the chain latency value of the current iteration of the control loop.

The total latency of the system 20 includes or consists of the sensor latency between the sensor 22 and the control unit 23, the actuator latency between the control unit 23 and the actuator 24 and a control latency which represents the time needed by the control unit 23 to execute the control functions.

FIG. 3 schematically shows a control or computing system 20 in which the techniques of the present disclosure can be used for controlling a distributed system. The computing system 20 is designed to execute the method 10 according to FIG. 1. The computing system 20 may be implemented in hardware and/or software. Accordingly, the system shown in FIG. 3 can be regarded as a computer program designed to execute the method 10 according to FIG. 1.

The latency estimator with actuator feedback presented here is used to address an optimization problem for the distributed system 20, whose target is selecting the control mode at each iteration that maximizes/minimizes a given objective function (e.g., minimized mean-squared error, minimized settling time, maximized control performance weighted on runtime complexity, etcetera). It can also be applied to other scenarios where knowing the delay at runtime is highly beneficial to make best decisions.

In its general form, the controller is implemented as a set of control functions (“control modes”) m₁, . . . , m_{N}, each of them optimized for a specific interval of chain or total latency. An arbitrary control mode mᵢ has execution time bounded in [Cᵢ^{low}, Cᵢ^{up}] and is univocally assigned to an interval of chain latencies [τ_{chain}^{low}(mᵢ), τ_{chain}^{up}(mᵢ)] within which it can operate with an average performance Pi. Such performance relates to the target objective to maximize/minimize. Here, the term performance could be any application/system property that the concrete application/system aims to optimize.

Based on the performance value Pᵢ (and possibly on other information from the objective function), each control mode may be assigned a (possibly dynamic) order of preference oᵢ, i.e., barring that the current latency is within its allowed bounds, it will be selected with preference oi. In synthesis, an arbitrary control mode mᵢ will have the following components

| Mode | Latency | | | Order of |
|---|---|---|---|---|
| ID | interval | Execution time | Performance | preference |
| mᵢ | [τ_{chain}^{low} (mᵢ), | [Cᵢ^{low}, Cᵢ^{up}] | Pᵢ | oᵢ |
| | τ_{chain}^{up} (mᵢ)] | | | |

The system may have safety-critical nature, and it can be potentially destabilized by variable network delays: Indeed, if a vehicle controller is tuned to a specific delay, but experiences a different delay, the system performance may deteriorate, thus leading to instabilities. Unfortunately, the delay value is affected by the combination of uncertain sources due to the computing platform and network communication, thus it can only be known partially or in an uncertain manner at the time of the control command calculation. Unlocking a better estimate of the delay at runtime may be used to choose the right control mode, optimized for the current status of the system.

In the following example, the distributed system 20 includes a sensor 22, a digital control unit 23, an actuator 24, and optionally a plant/process or technical system 21 to be controlled. The control unit 23 executes on a cloud or edge device, or on a dedicated processor with significatively larger computational power than a classic embedded device. The sensor 22, the control unit 23 and the actuator 24 are connected via a networked communication infrastructure or network 25. The control unit 23 implements as a set of control functions 23a, ctrl m₁, . . . , ctrl m_{N}, (called hereafter controller “modes”), each of them optimized for a specific latency or a specific interval of latencies. Each of these functions is univocally labelled (e.g., with an integer number).

The sensor 22, the control unit 23 and actuator 24 agree on a common notion of time (synchronized clocks) i.e., they are time synchronized. This can be obtained with state-of-the-art mechanisms (e.g., Precision Time Protocol), and may be repeated regularly to avoid the effects of clock drifting. The data passing through the control chain is timestamped at the beginning of each communication (sensor-to-control and control-to-actuator). The timestamp generated at the sensor level is propagated to the corresponding control command that is sent to the actuator 24.

The local actuator 24 has limited computational capabilities in a distributed system. It is able to compare the current time with the timestamped control input to obtain the actual sensor-to-actuator latency, and possibly compute a correcting term based on simple calculations between the estimated latency chain value and the real one. The application at the actuator level must also be capable of sending data back to the controller node through the network.

The estimator is implemented on the same node as the control unit 23, or in close connection to it but with negligible communication delay. For each iteration of the control chain, the estimator is executed strictly before starting the actual execution of the control function. It can be implemented as an independent task, or as the initial module of the control task. The estimator or estimator routine may be implemented in hardware and/or software.

FIG. 2 presents the structure of the system 20, highlighting the components of the chain delay. Estimates are hereafter denoted with a cap, i.e., if τₓ is the exact value of an arbitrary delay, \hat{τ}ₓ is its estimate. The proposed mechanism includes the following steps, performed at each iteration k=0, 1, 2 . . . of the periodic control process, before executing the control function:
Measuring the sensor-to-control latency τ_{sc,k}.
Estimating the control-to-actuator latency \hat{τ}_{ca,k}.

For each control mode mᵢ, estimating the response time \hat{τ}_{r,k}(mᵢ) of the control function, considering the possible interference from other concurrent tasks currently executing in the node, as well as the additional execution time from the estimation process itself. Combining all the components above with the correcting term εₖ, available at step k, provided by the logic at the actuator level, to obtain the total control chain latency estimation \hat{τ}_{chain,k}(mᵢ) for each control mode.

Using the estimated latency to select the most suitable control mode mᵢ for the current iteration k. The chosen control mode mᵢ is then executed and the control command is sent to the actuator. When the control command arrives at the actuator, the logic at the actuator level compares the estimated latency \hat{τ}_{chain,k}(mᵢ) with the actual measured latency τ_{chain,k} and sends back to the controller an updated correcting term for the next steps at the earliest at step (εₖ₊₁).

Depending on the chosen scheduler on the controller node (cloud/edge/zone/embedded) and on the communication protocols, the formulation of the delay estimation may be different. At the start of the estimator execution for the k-th iteration, the first element that is computed is the sensor-to-control latency τ_{sc,k}. Under the hypothesis that the clocks of the sensor and the controller nodes are synchronized, named t_{s,k} the time when the sensor data has been sampled, and t_{e,k} the start instant of the k-th estimator execution, it follows that

$${τ}_{sc , k} = {t}_{e , k} - {t}_{s , k} \qquad ( 1 )$$

The next components will be estimated, and will be computed as upper (and eventually lower) bounds. The control-to-actuator latency \hat{τ}_{ca,k} is estimated based on the state of the network and/or the history of observed delays. This computation can be done either by a service external to the application and provided as input to the estimator, or from an internal service with system knowledge on the status of the network (e.g., through predicted Quality of Service). Such service can also estimate the latency based on the latency in previous cycles. Depending on the actual protocol and infrastructure, the computation may require different approaches, and different accuracy. In certain setups, the history of τ_{sc,k} in the previous iterations can be used to estimate \hat{τ}_{ca,k}. We will consider a generic formulation ƒ_{c}(·) for the communication estimation, such that, accounting for an additional modelled uncertainty [Δ_{ca}⁻, Δ_{ca}⁺] from the network, the upper and lower bounds for \hat{τ}_{ca,k} can be computed as follows:

$${\hat{τ}}_{ca , k}^{up} = {f}_{c} ( {τ}_{sc , k} , network\_status ) + {Δ}_{ca}^{+} \qquad ( 2 )$$

$${\hat{τ}}_{ca , k}^{low} = {f}_{c} ( {τ}_{sc , k} , network\_status ) + {Δ}_{ca}^{-}$$

The response time estimation \hat{τ}_{r,k}(mᵢ) is an explicit function of the mode mᵢ, as each mode may have different execution times (e.g., simpler vs more complex control design). In general, the computation requires considering the execution time of the control mode mᵢ, as well as possible interference due to higher priority tasks (or due to budget assignments, depending on the scheduler) occurring in the interval \hat{τ}_{r,k}(mᵢ).

It is important to inflate the response time also considering the time it takes to run the estimator, namely Cₑₛₜ(mᵢ) (measured beforehand, or added at the end of the computation by measuring it at runtime). In its general form, the response time is indicated as a (recursive) function ƒᵣ(·) that depends on the execution time, the intrinsic effects from the scheduler (here denoted with Sched) and the response time itself.

The response time will also be upper- and lower-bounded in our calculations, finding \hat{τ}_{r,k}^{up}(mᵢ) and \hat{τ}_{r,k}^{low}(mᵢ), respectively.

$${\hat{τ}}_{r , k}^{up} ( {m}_{i} ) = {f}_{r} ( {C}_{i}^{up} + {C}_{est} ( {m}_{i} ) , Sched , {\hat{τ}}_{r , k}^{up} ( {m}_{i} ) ) \qquad ( 3 a )$$

$${\hat{τ}}_{r , k}^{low} ( {m}_{i} ) = {f}_{r} ( {C}_{i}^{low} + {C}_{est} ( {m}_{i} ) , Sched , {\hat{τ}}_{r , k}^{low} ( {m}_{i} ) ) \qquad ( 3 b )$$

State-of-the-art algorithms can be used to implement Eqs. (3a-b), such as classic reiterative algorithms or approximate approaches with polynomial complexity. The response time can also be used to check the schedulability of the chosen control mode, in case this is not ensured by design.

The total chain latency bounds \hat{τ}_{chain,k}^{up} (mᵢ) and \hat{τ}_{chain,k}^{low} (mᵢ) are then computed as:

$${\hat{τ}}_{chain , k}^{up} ( {m}_{i} ) = {τ}_{sc , k} + {\hat{τ}}_{ca , k}^{up} + {\hat{τ}}_{r , k}^{up} ( {m}_{i} ) + {ε}_{k} \qquad ( 4 a )$$

$${\hat{τ}}_{chain , k}^{low} ( {m}_{i} ) = {τ}_{sc , k} + {\hat{τ}}_{ca , k}^{low} + {\hat{τ}}_{r , k}^{low} ( {m}_{i} ) + {ε}_{k} \qquad ( 4 b )$$

and the intermediate value \hat{τ}_{chain,k} (mᵢ) of the estimate can be obtained e.g., as the average:

$${\hat{τ}}_{chain , k} ( {m}_{i} ) = ( {\hat{τ}}_{chain , k}^{up} ( {m}_{i} ) + {\hat{τ}}_{chain , k}^{low} ( {m}_{i} ) ) / 2 \qquad ( 4 c )$$

In Eqs (4a-b), εₖ is the correcting term available at step k at the control unit, that was computed at the actuator level, as a function of the latency error estimation of the previous step(s). It has a generic formulation in case of one-step late information as follows:

$${ε}_{k + 1} = {f}_{ε} ( {τ}_{chain , k} - {\hat{τ}}_{chain , k} ( {m}_{i} ) ) \qquad ( 5 )$$

Possible implementations of ƒ_{ε}(·) are, e.g., in the form of classic (discrete-time) PID design such as:

$${ε}_{k + 1} = ( {K}_{P} + {K}_{I} IF ( z ) + \frac{{K}_{D}}{{T}_{f} + DF ( z )} ) ( {\hat{τ}}_{chain , k} - {\hat{τ}}_{chain , k} ( {m}_{i} ) ) \qquad ( 6 )$$

with K_{P}, K_{I}, K_{D} being the PID gains, IF(z) being the integral formula, DF(z) the derivative formula and T_{f} the derivative filter period (the last three elements will depend on the chosen discretization method). The PID gains must be tuned to obtain a closed-loop stable behavior in the latency estimation.

To optimize the check across possible control modes, the following algorithm may be provided. It prioritizes checking the control modes with the best performance, i.e., starting by the one with highest order value oᵢ and cycling through the other modes in descending order. The algorithm stops at the first control mode that satisfies the latency constraints.
1. Measure sensor-to-control latency τ_{sc,k} (Eq. 1)
2. Compute estimated control-to-actuator latency \hat{τ}_{ca,k}^{up} and \hat{τ}_{ca,k}^{low} (Eq. 2)
3. For each control mode mᵢ, ordered following the index oᵢ
4. Compute estimated response time \hat{τ}_{r,k}^{up} (mᵢ) and \hat{τ}_{r,k}^{low} (mᵢ), (Eqs. 3a-b)
5. Optional: Check schedulability of mᵢ
6. Compute estimated chain latency \hat{τ}_{chain,k}^{up} (mᵢ), \hat{τ}_{chain,k}^{low} (mᵢ) and τ_{chain,k} (mᵢ) (Eqs. 4a-c)
7. If \hat{τ}_{chain,k}^{up} (mᵢ)≤τ_{chain,i}^{up} and τ_{chain,k}^{low} (mᵢ)≥τ_{chain,i}^{low}
8. Select mᵢ and exit
9. End If
10. End For

The control system 20 shown in FIG. 3 and according to the present disclosure can be summarized with the following sequence of actions. These actions may also be seen as a method for controlling a distributed system like the control system 20.

The sensor 22 samples the plant at step k∈[0, 1, 2, 3, . . . ] and obtains sensing data 26 which data is marked with yₖ. Data yₖ is timestamped at the source, i.e., it is associated with the corresponding (absolute) instant t_{s,k} when the sensed data has been obtained. The sensing data 26 may be generated periodically.

Sensor data 27 including the sensing data 26 together with the time information t_{s,k}, {t_{s,k}, yₖ}, is sent via the network 25 to the control unit 23. The transmitting or sending of the sensor data 26 may be periodically. The network 25 may be a wireless network e.g. a mobile network like a 5G network, the internet, WLAN or the like, or a wired connection, e.g., CAN or the like. The control unit 23 is located at an edge, cloud, zone or the like. Thus, some sensor to controller delay or latency τ_{sc} is present.

Synchronized with the sensor 22, the actuator 24 sends the latency correction term 28 to the control unit 23. For computing the latency correction term 28 the actuator 24 may include a computing unit 24a or may have access to a computing unit external to the actuator 24.

The estimator 29 of the control unit 23 is activated either periodically or event-driven (i.e., when the sensor data 27 and the latency correction term 28 are received), before the actual control function is started at the control unit 23. It then performs the following steps:

Based on the current time and the timestamp t_{s,k} of the sensed data, it computes τ_{sc} (Eq. 1).

Based on the information on the network status, it estimates the upper and lower bounds \hat{τ}_{ca,k}^{up} and \hat{τ}_{ca,k}^{low} (Eq. 2).

Based on the information of the control node, it estimates the upper and lower bounds \hat{τ}_{r,k}^{up} and \hat{τ}_{r,k}^{low} (Eqs. 3a-b).

Adding all the components above with the correcting term εₖ, it obtains latency \hat{τ}_{chain,k}^{up} (mᵢ), \hat{τ}_{chain,k}^{low} (mᵢ) and \hat{τ}_{chain,k} (mᵢ) (Eq. 4a-c).

It selects the best mode mᵢ (in terms of performance) such that the estimated time latencies are within the bounds of that mode.

Then after these estimator steps, the selected control mode mᵢ is then executed using the sensed data yₖ.

At the end of the controller execution, the control command uₖ i.e., the control input 30 to the actuator 24 is produced. The control input 30 is then sent to the actuator 24 via the network 25, associated with the sensor timestamp t_{s,k} and with the estimated latency value τ_{chain,k} (mᵢ).

When the actuator 24 receives the control command uₖ, it applies it to the plant 21. The computing unit 24a at the actuator 24 computes the actual chain latency using its current time t_{a,k} and the sensor timestamp, i.e., τ_{chain,k}=t_{a,k}−t_{s,k}. Based on this value, the actuator computes the new updated correcting value (Eqs. 5-6). Then, the cycle restarts from Step 1.

In an alternative implementation the computation of the correcting term is done by the estimator 29 instead of at the actuator level. In this case, the actuator 24 is required only to send the value τ_{chain,k}. Also, the estimator 29 is required to store in memory the computed estimate τ_{chain,k}(mᵢ) in order to correctly compute the correcting term, by comparing it with the corresponding actual latency τ_{chain,k}.

FIG. 4 schematically shows a control system 40 in which the techniques of the present disclosure can be used for controlling a distributed system. The control system 40 is designed to execute the method 10 according to FIG. 1. The control system 40 may be implemented in hardware and/or software.

FIG. 4 schematically shows the context of controlling the (longitudinal) motion of one or more vehicles 41 over a network 42, e.g. through an edge device like a roadside unit. The vehicle 41 like a passenger car, a commercial vehicle, an e-bike or the like communicates via the network 42 with a control unit 43. The control unit 43 may correspond to the control unit 23 of FIG. 3. Accordingly, the sensor 22 and the actuator 24 are implemented in the vehicle 41. The vehicle 41 or parts of the vehicle 41 may correspond to the system 21 of FIG. 3. In the case shown in FIG. 4, the control goal is keeping a reference distance 44 of another vehicle 45. The vehicle 45 may be leading vehicle 41 which follows vehicle 45 in an automated driving mode.

The setup shown in FIG. 4 is one possible application where the present disclosure may provide significant benefits. Without a delay-adaptive control, the closed-loop system is potentially destabilized by the network delays or may be tuned with a poor performance. This would lead to the restriction that only large distances to the surrounding vehicles will be possible. Due to the safety-critical nature of the system, collisions are likely to occur as a consequence of poor performance. If the vehicle controller is tuned to a specific amount of delay e.g. the worst case, experiencing instead a smaller amount of delay may also deteriorate the resulting performance and lead to instabilities.

Thus, the absence of knowledge of the current delay in the control algorithm traditionally hinders good performance. Especially in cases where the control algorithm resides in a zone, edge or cloud environment, the actual round-trip delay τ is by-design unknown or uncertain when the control input is computed, since there is a network-link in between. In addition, the particular value of the delay is of stochastic nature and typically varying over time depending on the network congestion. Using the proposed mode-based control scheme with feedback of the local actuor, this dilemma can be overcome. Multiple controller modes Ctrl m₁, . . . . Ctrl m_{N} can be designed for the relevant ranges of delay. Since the information of the current or real delay is available before a possible control signal for the actuator 24 is calculated at the control unit 43, the best control signal for the current amount of delay can be picked. This decouples the tradeoff between delay-caused robustness and the required performance.

What is claimed is:

1. A method for estimating latency in a network distributed system with at least one sensor, a control unit, and an actuator for actuating on a technical system, comprising:
determining a sensor latency between the sensor and the control unit based on sensor time information;
estimating an actuator latency between the control unit and the actuator;
providing multiple control functions each concerning a different estimated total latency, wherein the estimated total latency includes the sensor latency, the actuator latency and a control latency;
providing a latency correction term based on a comparison between the estimated total latency and a measured total latency;
calculating a corrected total latency by using the latency correction term, available at the time of the estimation, to the total latency;
selecting and executing a control function from the multiple control functions for which the corrected total latency lies within a latency range of this control function and calculating a control input from the selected control function;
transmitting the control input to the actuator via the network; and
applying, by the actuator, the control input to the technical system.

2. The method according to claim 1, further comprising the following initial method steps:
receiving, at the control unit, sensing data and time information from the sensor;
calculating, at the actuator, the latency correction term and transmitting the latency correction term to the control unit; and
executing, at the control unit, the steps of estimating an actuator latency, calculating a corrected total latency, selecting a control function, and transmitting the control input.

3. The method according to claim 2, wherein the control unit transmits the control input to the actuator together with the time information from the sensor and the estimated total latency.

4. The method according to claim 1, wherein the estimated actuator latency is derived from at least one of historical data, network observation, run-time estimations, calculation delays and sensor latency.

5. The method according to claim 1, wherein the time information includes an absolute time information such as a time stamp or a relative indication of time.

6. The method according to claim 1, wherein the control functions are ranked by best performance and wherein selecting a control function from the multiple control functions starts with the highest ranked control function and continues to lower ranked control functions until a control function is identified for which the corrected total latency lies within the latency range of this control function.

7. The method according to claim 1, wherein the control unit, the sensor, and the actuator are time synchronized.

8. The method according to claim 1, wherein the total latency consists of the sensor latency and the actuator latency when the sensor latency and the actuator latency are large compared to the control latency.

9. The method according to claim 1, wherein the sensor measures at least one property of the technical system and outputs sensing data to the control unit, and wherein the actuator receives a control input from the control unit and actuates at least one property of the technical system according to the control input.

10. A control system configured to perform the method according of claim 1, wherein the distributed system comprises at least one sensor, a control unit, and an actuator.

11. The control system according to claim 10, wherein the distributed system comprises a technical system which is included in a close loop control with the sensor, the control unit, and the actuator.

12. A computing system configured to perform the method according to claim 1.

13. A computer program configured to perform the method according to claim 1.

14. A computer readable medium or signal storing and/or containing the computer program according to claim 13.
